(19) United States
(12) Patent Application Publication
(10) Pub. No.: US 2022/0145618 A1
(43) Pub. Date: May 12, 2022

(54) ACOUSTIC OBSTRUCTION PREVENTION EQUIPMENT AND DESIGN METHOD THEREOF

(71) Applicant: NIPPON ENVIRONMENT AMENITY CO., LTD., Tokyo (JP)

(72) Inventor: Shimpei Yatsunami, Tokyo (JP)

(21) Appl. No.: 17/598,697

(22) PCT Filed: Nov. 8, 2019
(86) PCT No.: PCT/JP2019/043852

§ 371 Date: Sep. 27, 2021

(30) Foreign Application Priority Data
Mar. 28, 2019 (JP) 2019-064633

(51) Int. Cl. E04B 1/99; G10K 11/16; G10K 15/00

(52) U.S. Cl. CPC E04B 1/99; G10K 2210/12; G10K 15/00; G10K 11/16

(57) ABSTRACT

Provided are acoustic obstruction prevention equipment for preventing acoustic obstruction by appropriately designing a surface structure of elemental surfaces that surround a space or a surface structure of an acoustic diffuser, and a design method thereof.

A plurality of elemental surfaces that form wall surfaces, a ceiling surface, or a floor surface which surround a space are provided. An angle mutually formed by the elemental surfaces is nα (n is a natural number), and acoustic obstruction is prevented by reflection between the elemental surfaces. φ=(1+sqrt(5))/2, α=360°*1/(1+φ). This technique may be used for a plurality of other elemental surfaces that form an acoustic diffuser disposed in a space. Furthermore, the acoustic diffuser may also be formed by rotating and disposing a plurality of units at the above-described angle multiple times.

### TECHNICAL FIELD

The present invention relates to acoustic obstruction prevention equipment and a design method thereof. More specifically, the present invention relates to acoustic obstruction prevention equipment structured by a plurality of elemental surfaces that form wall surfaces, a ceiling surface, or a floor surface which surround a space, acoustic obstruction prevention equipment that includes an acoustic diffuser disposed in a space or the like surrounded by the elemental surfaces, and a design method thereof.

### BACKGROUND ART

Acoustic obstruction such as flutter echo, long path echo, and acoustic concentration needs to be prevented in, for example, concert halls, music studios, and the like. As measures for preventing such acoustic obstruction, various acoustic diffusers such as an acoustic diffusion panel disclosed in Patent Document 1 as techniques for preventing multiple echo and individually adjusting diffusion of sound and the like are suggested. In the acoustic diffusion panel, a pivotal portion is disposed and an angle of the panel can be thus changed, so that sound absorption and a reflection direction are individually adjusted on site to prevent acoustic obstruction.

### CITATION LIST

### Patent Documents

[PATENT DOCUMENT 1] Japanese Laid-Open Patent Publication No. 2006-300995

### SUMMARY OF THE INVENTION

### Problems to be Solved by the Invention

In view of such circumstances of conventional techniques, an object of the present invention is to provide acoustic obstruction prevention equipment for preventing acoustic obstruction by appropriately designing a surface structure of elemental surfaces that surround a space or a surface structure of an acoustic diffuser, and a design method thereof.

### Solution to the Problems

In order to achieve the aforementioned object, a first configuration of acoustic obstruction prevention equipment according to the present invention includes a plurality of elemental surfaces that form wall surfaces, a ceiling surface, or a floor surface which surround a space, an angle mutually formed by the elemental surfaces is nα (n is a natural number), and acoustic obstruction is prevented by reflection between the elemental surfaces.

$$φ = ( 1 + sqrt ( 5 ) ) / 2$$

$$α = 360 ° * 1 / ( 1 + φ )$$

For example, FIGS. 1 and 2 illustrate the above-described configuration, FIG. 14 illustrates the effect, and the “elemental surfaces” are represented as first elemental surfaces SR, Sr0, 1, . . . . In this configuration, an angle between the elemental surfaces is defined by an angle nα that is n times an angle α defined by a so-called golden ratio (1:φ), n being a natural number. The angles defined in this manner do not appear as the same angle even when the rotation is repeated, according to the characteristics of the golden ratio. Therefore, for example, a plurality of elemental surfaces that form wall surfaces, a ceiling surface, or a floor surface which surround a space do not become parallel to each other, and occurrence of flutter echo and the like in multiple echo can be effectively prevented.

A second configuration of acoustic prevention equipment according to the present invention includes a plurality of other elemental surfaces that form an acoustic diffuser disposed in a space, an angle mutually formed by the other elemental surfaces is nα (n is a natural number), and acoustic obstruction is prevented by reflection between the other elemental surfaces or reflection between elemental surfaces surrounding the space and the other elemental surfaces.

$$φ = ( 1 + sqrt ( 5 ) ) / 2$$

$$α = 360 ° * 1 / ( 1 + φ )$$

For example, FIG. 1 illustrates the second configuration, FIG. 14 illustrates the effect, “the other elemental surfaces are represented as second elemental surfaces SV, Sv0, 1, 2 . . . and the third elemental surfaces SH, Sh0, 1, 2 . . . , and the acoustic diffusers O are represented as vertical acoustic diffusers OV, Ov0, 1, 2 . . . and horizontal acoustic diffusers OH, Oh0, 1, 2 . . . . In this configuration, an angle mutually formed by the plurality of other elemental surfaces that form the acoustic diffuser disposed in the space is also designed as nα. As a result, acoustic obstruction is prevented by the other elemental surfaces according to the above-described principle.

In each of the above-described configurations, each of the elemental surfaces or each of the other elemental surfaces may have a substantially rectangular shape, and a length-width ratio of each of the elemental surfaces may be 1:φ. In the first configuration, the wall surfaces, the ceiling surface, or the floor surface which surround the space may form a substantially rectangular parallelepiped shape, and a ratio of three sides of the rectangular parallelepiped may be 1/φ:1:φ. For example, FIG. 3 illustrates these examples.

In a case where a so-called golden ratio is applied to, for example, the elemental surfaces, the other elemental surfaces, or the substantially rectangular parallelepiped that forms the space, acoustic obstruction caused by, for example, enhancing or weakening waves at a specific frequency on the surfaces and in the space can be prevented.

A third configuration of acoustic obstruction prevention equipment according to the present invention includes an acoustic diffuser disposed in a space, the acoustic diffuser includes a plurality of units, the units have almost similar shapes or a same shape, and each unit has small faces on surfaces, each unit is disposed such that an angle mutually formed by the units is nα (n is a natural number), and acoustic obstruction is prevented by reflection between the small faces or reflection between elemental surfaces surrounding the space and the small faces.

$$φ = ( 1 + sqrt ( 5 ) ) / 2$$

$$α = 360 ° * 1 / ( 1 + φ )$$

For example, FIGS. 4 to 13 illustrate the third configuration and FIG. 15 illustrates the effect. In this configuration, each unit is disposed such that an angle mutually formed by the units is nα (n is a natural number). Therefore, as in each of the above-described configurations, the small faces of the units are also prevented from having the same angle. Therefore, acoustic obstruction is prevented according to the above-described similar principle.

Mutual rotation, among the units, which defines angles mutually formed by the units includes revolution of each unit in a world coordinate system and/or rotation of each unit in a local coordinate system, the rotation of each unit defining an orientation of each unit.

The units in each acoustic diffuser may be repeatedly formed so as to be displaced in the world coordinate system, and a distance L between the units or a distance L between each unit and a reference axis in the world coordinate system or an originating point in the world coordinate system may be defined by an equal magnification, any magnification, or an nφ times magnification (n is a natural number).

Particularly, in a case where the distance L between the units or the distance L between each unit and the reference axis or the like is defined by nφ times, acoustic obstruction caused by regularity of the distances between the units can be prevented. Furthermore, the distances are sequentially increased, whereby, for example, overlapping of the units can be prevented.

Each of the units in each acoustic diffuser may be enlarged by an equal magnification, any magnification, or an nφ times magnification (n is a natural number).

By also enlarging each unit according to increase of the distance, the units can be prevented from interfering with each other, and, by enlarging each unit by nφ times, acoustic obstruction caused by regularity of the sizes of the units can be prevented.

Each of the units may be designed as a polyhedral body or a curved body. In the case of the polyhedral body, acoustic diffusion further progresses from the vertexes of each polyhedral body as the starting points in multiple directions to prevent acoustic obstruction.

A configuration of acoustic obstruction prevention equipment including both the acoustic obstruction prevention equipment described in the first configuration and the second acoustic obstruction prevention equipment having the acoustic diffuser includes the acoustic diffuser disposed in the space surrounded by the plurality of elemental surfaces.

A design method of the first acoustic obstruction prevention equipment is configured such that a plurality of elemental surfaces that form wall surfaces, a ceiling surface, or a floor surface which surround a space are provided, an angle mutually formed by the elemental surfaces is nα (n is a natural number), and the elemental surfaces are selected such that acoustic obstruction is prevented by reflection between the elemental surfaces. For example, FIGS. 1 and 2 illustrate this configuration.

$$φ = ( 1 + sqrt ( 5 ) ) / 2$$

$$α = 360 ° * 1 / ( 1 + φ )$$

A design method of the second acoustic obstruction prevention equipment is configured such that a plurality of other elemental surfaces that form an acoustic diffuser disposed in a space are provided, an angle mutually formed by the other elemental surfaces is nα (n is a natural number), and the elemental surfaces are selected such that acoustic obstruction is prevented by reflection between the other elemental surfaces or reflection between elemental surfaces surrounding the space and the other elemental surfaces. For example, FIG. 1 illustrates this configuration.

$$φ = ( 1 + sqrt ( 5 ) ) / 2$$

$$α = 360 ° * 1 / ( 1 + φ )$$

A design method of the third acoustic obstruction prevention equipment is configured such that an acoustic diffuser is disposed in a space, and the acoustic diffuser includes a plurality of units, the units have almost similar shapes or a same shape, and each unit has small faces on surfaces, each unit is disposed such that an angle mutually formed by the units is nα (n is a natural number), and the units are formed and disposed such that acoustic obstruction is prevented by reflection between the small faces or reflection between elemental surfaces surrounding the space and the small faces. For example, FIGS. 4 to 13 illustrate this configuration.

$$φ = ( 1 + sqrt ( 5 ) ) / 2$$

$$α = 360 ° * 1 / ( 1 + φ )$$

### Advantageous Effects of the Invention

According to the characteristics of the acoustic obstruction prevention equipment and the design method thereof according to the present invention, the acoustic obstruction prevention equipment for preventing acoustic obstruction by appropriately designing a surface structure of elemental surfaces that surround a space or a surface structure of an acoustic diffuser, and the design method thereof can be provided.

The other objects, configuration, and effects of the present invention will become apparent from the following description of embodiments of the present invention.

### BRIEF DESCRIPTION OF THE DRAWINGS

FIG. 1 is a stereographic view of a room in which wall surfaces of the room and pillar-shaped acoustic diffusers are implemented as acoustic obstruction prevention equipment of the present invention.

FIG. 2 illustrates a procedure for designing the wall surfaces of the room as the acoustic obstruction prevention equipment of the present invention, FIG. 2A illustrates sides formed at angles nα from an Xw, Zw plane, and FIG. 2B illustrates a process of forming the wall surfaces by using the sides.

FIG. 3A illustrates a length-width ratio in the case of elemental surfaces of the wall surfaces and the pillar-shaped acoustic diffuser being formed, and FIG. 3B illustrates a length-width-height ratio in the case of a three-dimensional body of the entire room or a three-dimensional body of the individual pillar-shaped acoustic diffuser being formed.

FIG. 4 is a stereographic view of examples of acoustic diffusers disposed in a space.

FIG. 5 is a stereographic view of an example of an acoustic diffuser.

FIG. 6 is a plan view illustrating an example of arrangement of units that form an acoustic diffuser (the units revolve and rotate in increments of α, the scale is magnified by φ at each unit, and a distance L from the center (originating point Ow in world coordinates) is magnified by φ at each unit).

FIG. 7 is a plan view illustrating another example of arrangement of units that form an acoustic diffuser (the units revolve and rotate in increments of α, and the scale and the distance L from the center (originating point Ow in the world coordinates) are each equal among the units).

FIG. 8 is a plan view illustrating another example of arrangement of units that form an acoustic diffuser (the units revolve in increments of α, each unit does not rotate, and the scale and the distance L from the center (originating point Ow in the world coordinates) are each equal among the units).

FIG. 9 is a plan view illustrating another example of arrangement of units that form an acoustic diffuser (the units revolve in increments of α, the units rotate in increments of 2α, the scale is magnified by φ at each unit, and the distance L from the center (originating point Ow in the world coordinates) is magnified by φ at each unit).

FIG. 10 is a plan view illustrating another example of arrangement of units that form an acoustic diffuser (the units do not revolve in the world coordinate system, the units rotate in increments of α, each unit performs equal linear movement L, and the scales are equal among the units).

FIG. 11 is a plan view illustrating another example of arrangement of units that form an acoustic diffuser (the units do not revolve in the world coordinate system, the units rotate in increments of α, the linear movement L is magnified by φ at each unit, and the scales are equal among the units).

FIG. 12 illustrates an example in which, in a state where a three-dimensional shape includes a plurality of growth center points, a growth rule in FIG. 5 is applied to each growth center point, FIG. 12A illustrates a regular-icosahedron-shaped body in which each vertex is the growth center point, and FIG. 12B illustrates an acoustic diffuser in which each vertex in FIG. 12A is the growth center point.

FIG. 13 is a plan view of other examples of arrangement of units that form an acoustic diffuser, FIG. 13A illustrates a case where each unit does not revolve and a distance from the center axis to, for example, an originating point of each unit in local coordinates is zero, FIG. 13B illustrates a case where the distances from the center axis are equal among the units, and the units revolve in increments of an angle α, FIG. 13C illustrates a case where the distance from the center axis is magnified by nφ at each unit in the structure in FIG. 13B, and FIG. 13D illustrates a case where each unit is rotated about all the local coordinate axes by the angle α in the structure in FIG. 13A.

FIG. 14A illustrates an example of comparison indicating difference in acoustic diffusion between a room according to the technique in FIG. 2 and a general room, and illustrates the room according to the technique in FIG. 2.

FIG. 14B illustrates an example of comparison indicating difference in acoustic diffusion between the room according to the technique in FIG. 2 and a general room, and illustrates the general room.

FIG. 15A illustrates an example of comparison indicating difference in acoustic diffusion between a general room and a room in which an acoustic diffuser according to the technique in FIG. 5 or the like is disposed, and illustrates the room in which the acoustic diffuser according to the technique in FIG. 5 or the like is disposed (and illustrates “a plan view”, “a left side view”, “a front view”, and “a perspective view” clockwise from the upper right corner when the left end in FIG. 15A is positioned on the upper side, and the same applies to FIG. 15B).

FIG. 15B illustrates an example of comparison indicating difference in acoustic diffusion between a general room and a room in which the acoustic diffuser according to the technique in FIG. 5 or the like is disposed, and illustrates the room in which an acoustic diffuser according to a general technique is disposed.

### DESCRIPTION OF EMBODIMENTS

Next, the present invention will be more specifically described with appropriate reference to the accompanying drawings.

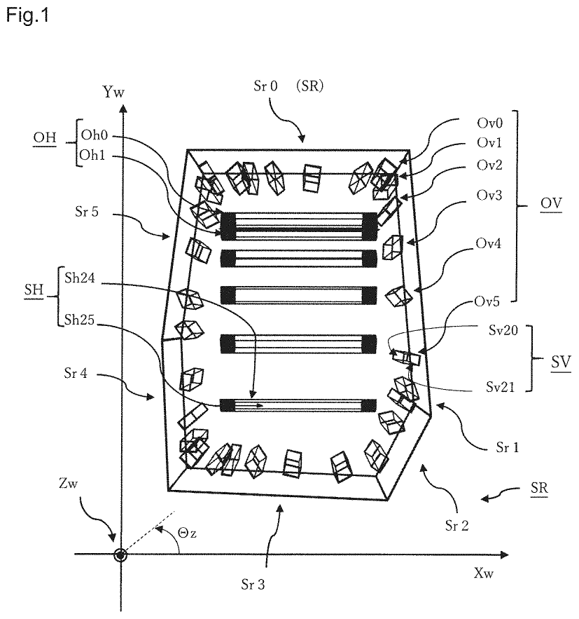

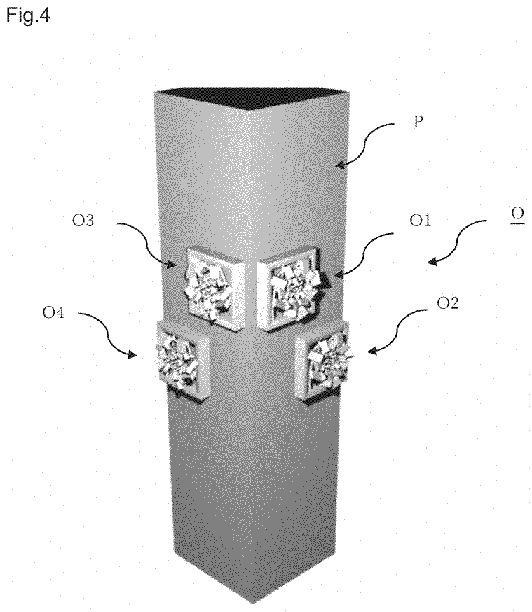

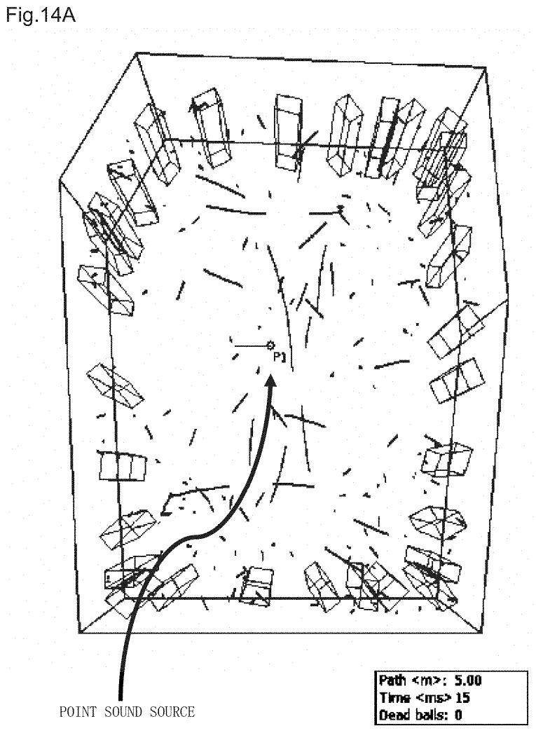

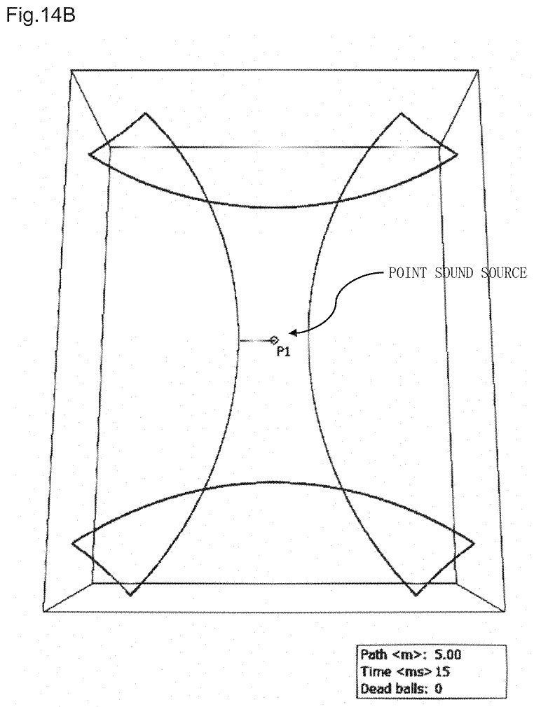

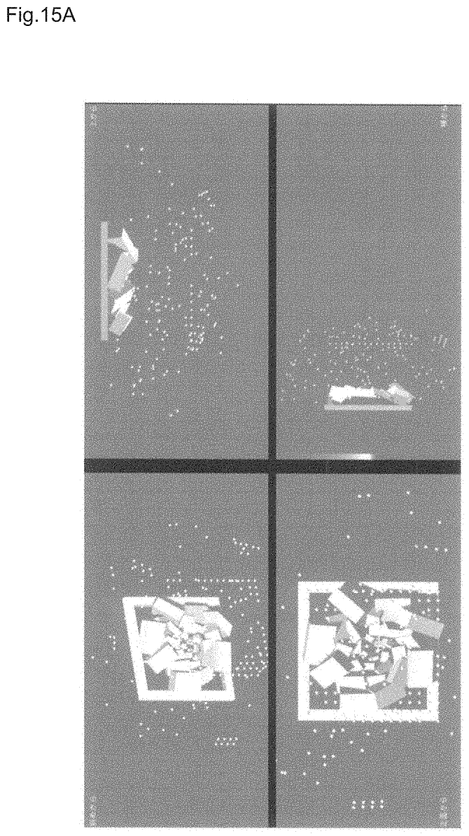

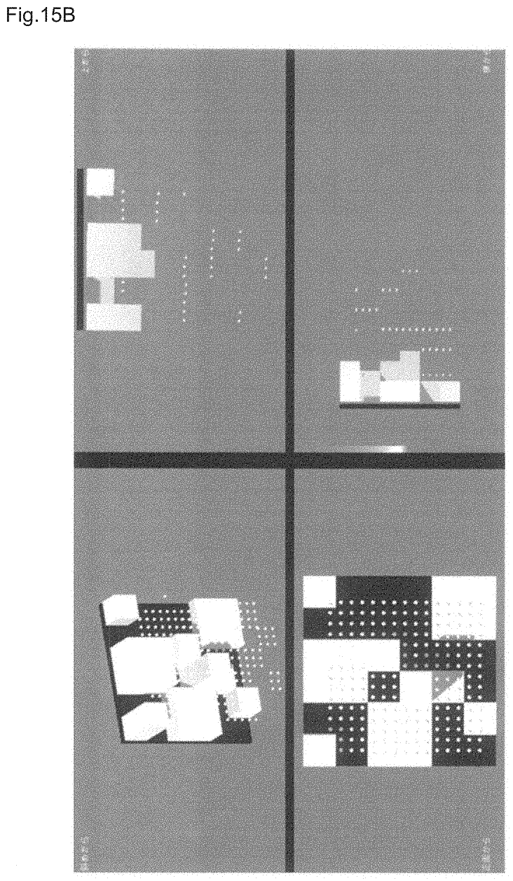

Acoustic obstruction prevention equipment and a design method thereof according to the present invention include a technique in which elemental surfaces and the like shown in FIGS. 1 to 3 are rotated to form wall surfaces and the like, and an acoustic diffuser (see FIG. 14 for the effect), and a technique in which units shown in FIGS. 4 to 13 are rotated to form an acoustic diffuser (see FIG. 15 for the effect).

Firstly, a procedure for designing a room will be described with reference to FIGS. 1 to 3. A stereographic view (perspective plan view) of a room in which wall surfaces of the room and pillar-shaped acoustic diffusers are implemented as the acoustic obstruction prevention equipment of the present invention, is illustrated. In the present embodiment, the wall surfaces are formed of a first elemental surface (elemental surfaces) SR (Sr0 to 5). In the present embodiment, designing can be performed in a case where angles between the elemental surfaces and positions of the elemental surfaces are defined. Therefore, representation is performed merely by a world coordinate system (Xw, Yw, Zw). An angle of each of the elemental surfaces Sr0 to 5 is defined by an angle Θw around the Zw axis.

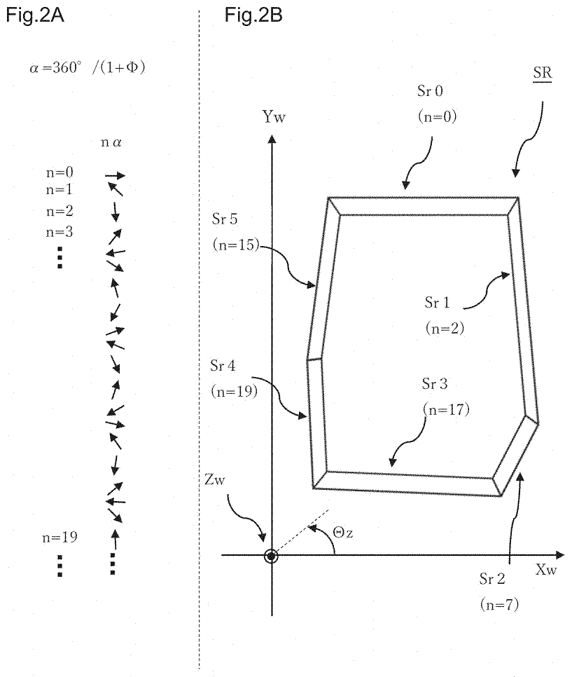

FIG. 2 illustrates a procedure for designing the wall surfaces of the room as the acoustic obstruction prevention equipment of the present invention, and FIG. 2A illustrates sides formed at angles Θw=nα (n represents zero and natural numbers) around the Zw axis from an Xw, Zw plane. The state of the rotation is represented by using vectors. n is sequentially changed in increments of one, and the formed surface is indicated lateral thereto.

φ and α are defined as follows.

$$φ = ( 1 + sqrt ( 5 ) ) / 2$$

$$α = 360 ° * 1 / ( 1 + φ )$$

That is, α represents an angle obtained by dividing 360° at a so-called golden ratio 1:φ. By repeating the integral multiple of the angle, a plurality of surfaces which are not mathematically the same are formed

Then, as shown in FIG. 2B, the surfaces formed as in FIG. 2A are selected and used as appropriate according to an approximate layout of the space forming the wall surfaces, to form the first elemental surfaces SR, Sr0 to 5. In FIG. 2B, for each first elemental surface, the surface Sr0 formed at n=0, the surface Sr1 formed at n=2, the surface Sr2 formed at n=7, the surface Sr3 formed at n=17, the surface Sr4 formed at n=19, and the surface Sr5 formed at n=15, are used.

The first elemental surfaces Sr0 to 5 selected and formed in this manner are not parallel to each other because of characteristics of the angles based on the golden ratio, to prevent acoustic obstruction such as flutter echo. This can also be utilized for the wall surfaces, a ceiling surface, and a floor surface, and the rotation axis may be changed to Xw, Yw, or the like in each case.

In a space surrounded by the first elemental surface SR, as shown in FIG. 1, a vertical acoustic diffuser OV (Ov0, Ov1, Ov2 . . . ) and a horizontal acoustic diffuser OH (Oh0, Oh1, Oh2 . . . ) are further disposed. The vertical acoustic diffuser OV is formed by aligning second elemental surfaces (other elemental surfaces) SV (Sv20, Sv21, and the like) formed about the Zw axis, around a pillar-shaped object, similarly to the first elemental surface SR. Meanwhile, the horizontal acoustic diffuser OH is formed by aligning third elemental surfaces (other elemental surfaces) SH (Sh24, Sh25, and the like) formed about the Xw axis, around the pillar-shaped object, unlike the first elemental surface SR. Similarly, the horizontal acoustic diffuser may be formed by rotating the elemental surfaces around the Yw axis.

In each of the above-described embodiments, the first to the third elemental surfaces SR, SV, SH are formed by rotating surfaces around any of the Xw, Yw, and Zw axes. However, the surfaces may be rotated around an axis other than these axes, or the surfaces may be rotated around a combination of two or more axes. An acoustic diffuser similar to an acoustic diffuser included in embodiments illustrated by FIG. 4 and the subsequent figures can be designed according to selection of an axis.

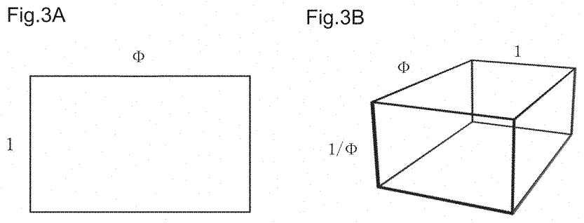

When each of the above-described first to third elemental surfaces SR, SV, SH is formed, the length-width ratio of the elemental surface may be determined as 1:φ as shown in FIG. 3A. Furthermore, as shown in FIG. 3B, the ratio of three sides of the entire room as a space surrounded by the first elemental surfaces SR, the vertical acoustic diffuser OV, or the horizontal acoustic diffuser OH may be determined as 1/φ:1:φ. Thus, flutter echo or the like due to a ratio of the sides of each elemental surface, the entire room, or the acoustic diffuser can be prevented.

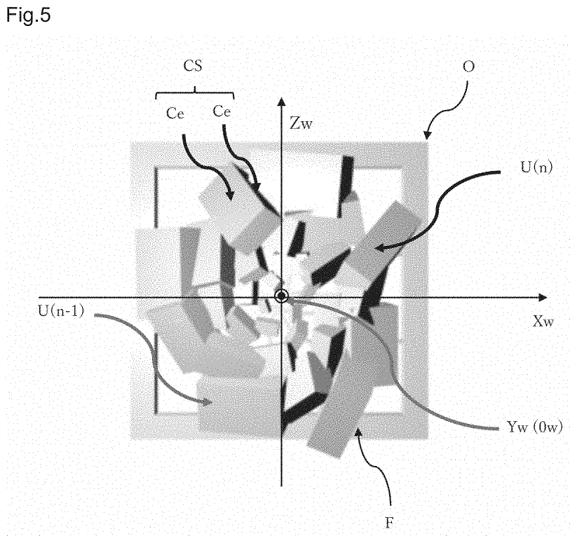

Next, a method for forming the acoustic diffuser by rotating units will be described with reference to FIGS. 4 to 13. In FIG. 4, a plurality of acoustic diffusers O (O1 to O4) are mounted to a pillar P. FIG. 5 illustrates each acoustic diffuser O in an enlarged manner, and each unit U shaped in a rectangular parallelepiped is caused to revolve around the Yw axis as a reference axis in the world coordinate system. Furthermore, the units U are caused to rotate around the respective axes in the local coordinates such that a distance from the reference axis or the like (including both the reference axis Yw and the originating point Ow in the world coordinates) is increased and the dimensions are also enlarged, as can be understood from comparison between one unit Un and another unit U(n−1) generated immediately before the one unit Un by one. The units U are connected to each other by an axis, and fixed on a frame F. The surfaces of each unit U are elemental faces Ce, Ce, and an aggregation thereof for each unit U is referred to as a small face CS.

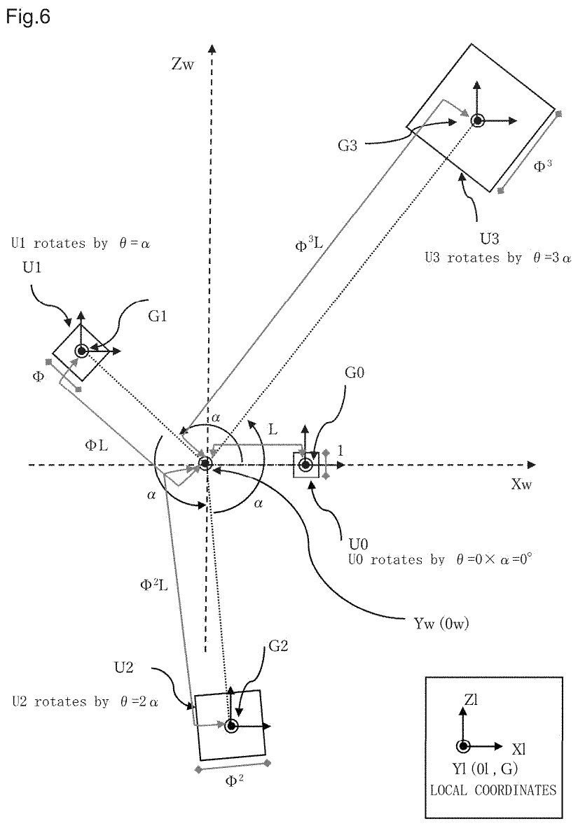

FIG. 6 to FIG. 9 each illustrate an example in which a regular-octahedron-shaped body is used as each unit U. Two vertexes of the regular-octahedron-shaped body on the Yw side are located on the front side and the depth side on the surface of the drawing sheet. Sides between these two vertexes and four vertexes shown in each figure are not indicated. The local coordinate system of each unit U1 is represented by X1, Y1, Z1, and an originating point in the local coordinates or a unit generation point is represented by G1 (X1, Y1, Z1, G1 for a unit U1).

FIG. 6 is a plan view illustrating an example of arrangement of units U forming the acoustic diffuser. In this example, the units revolve around the world reference axis Yw and rotate around the respective unit reference axes Y1 in increments of α, the scale is magnified by φ at each unit, and a distance L from the center is magnified by φ at each unit.

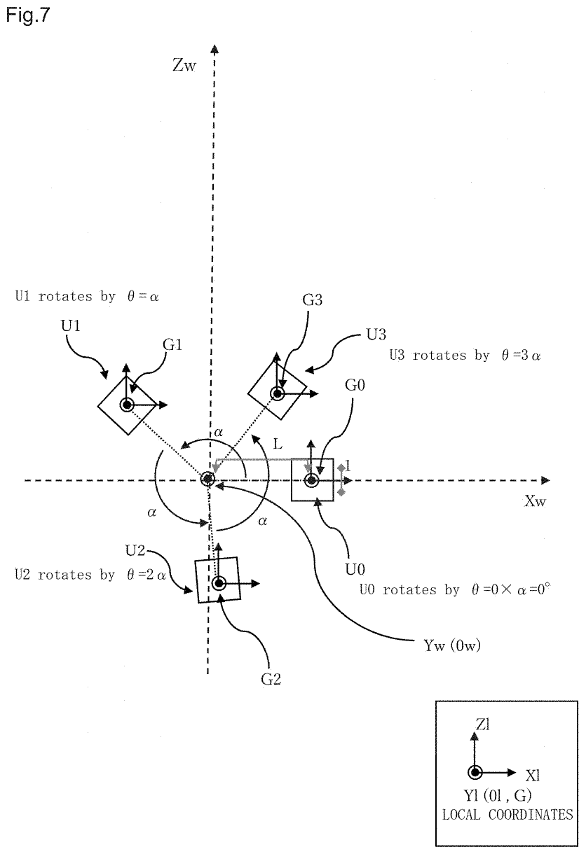

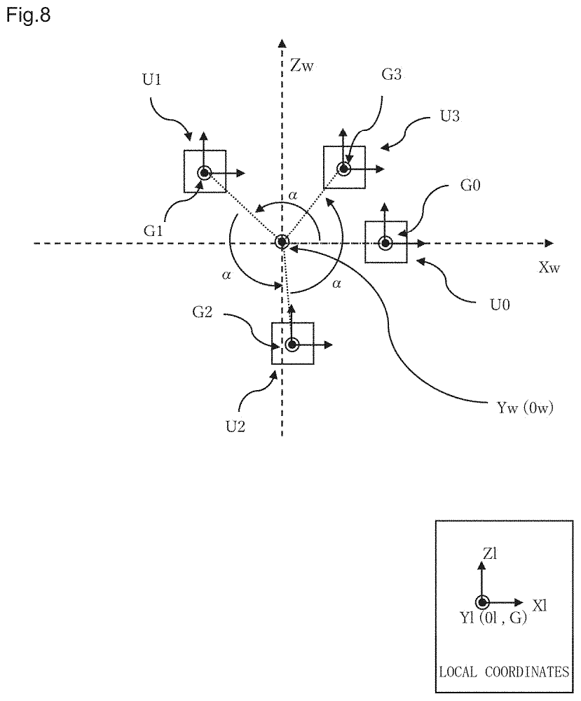

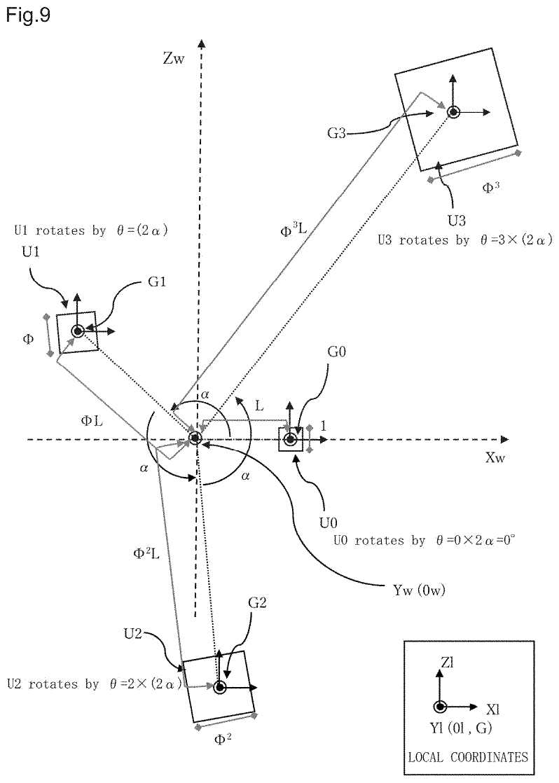

In FIG. 7, the units revolve around the world reference axis Yw and rotate around the respective unit reference axes Y1 in increments of α. However, in this example, the scale is equal among the units, and the distance L from the center is fixed and is not increased at each unit. The state in FIG. 8 is the same as the state in FIG. 7 except that the units do not rotate around the respective unit reference axes Y1 in FIG. 8. The state in FIG. 9 is the same as the state in FIG. 6 except that the units rotate around the respective unit reference axes Y1 in increments of 2α in FIG. 9.

As can be understood from the comparison among these figures, in a case where the distance L from the center is magnified by φ at each unit, the units are prevented from interfering with each other on the arrangement of the units. In a case where the scale is magnified by φ at each unit, the units can be reasonably enlarged and disposed. These magnifications by φ prevent flutter echo and the like due to a ratio among mutual dimensions and thus contribute to prevention of acoustic obstruction.

In a case where each unit revolves and rotates by α, an effect similar to that described above with reference to FIGS. 1 to 3 can be obtained in that sides parallel to an acoustic reflection surface do not appear. Furthermore, as shown in FIG. 8, also in a case where the units do not rotate, positions at which the vertexes of each unit appear are determined by the angle α based on the golden ratio, and reflected sounds having different phases are generated from these vertexes, resulting in a similar effect being obtained.

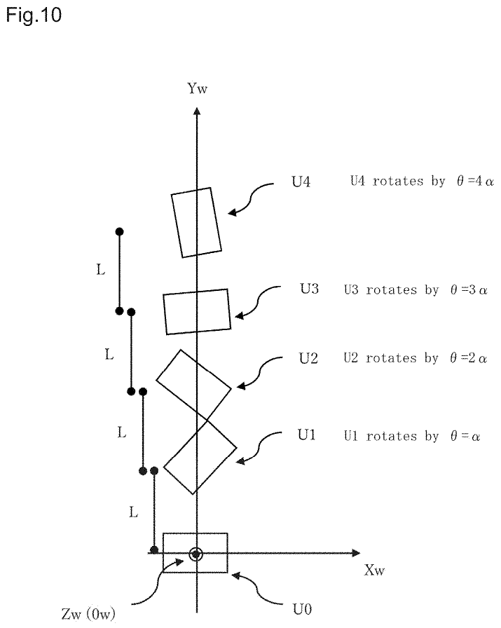

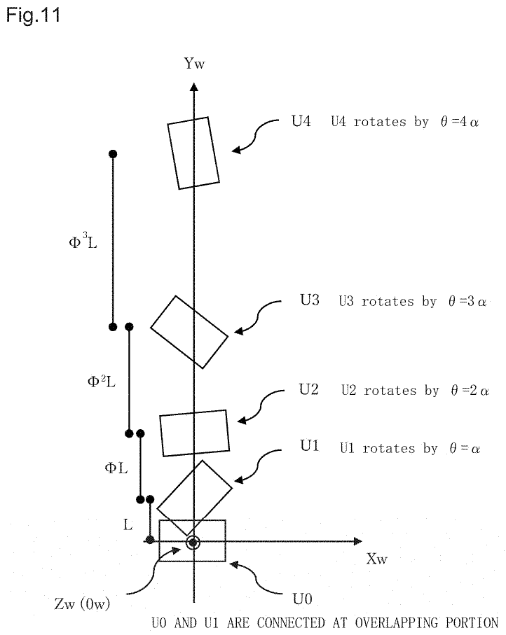

In examples shown in FIGS. 10 and 11, each unit U is rectangular-parallelepiped-shaped, and does not revolve and merely rotates around a local coordinate axis. In both FIGS. 10 and 11, the units rotate in increments of α around the local reference axes parallel to the world reference axis Zw. In the example shown in FIG. 10, each unit is displaced by the distance L in the Yw axis direction. In the example shown in FIG. 11, each unit is displaced in the Yw axis direction by the distance L that is magnified by φ at each unit. As shown in the example in FIG. 11, in a case where two units overlap each other, the two units may be generated so as to be connected to each other. This applies to all of the above-described examples.

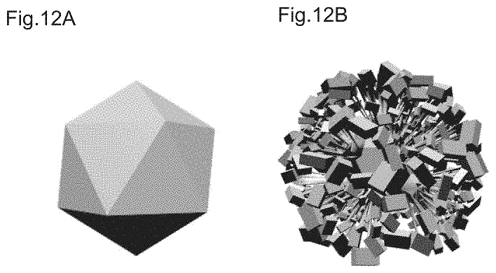

FIG. 12 illustrates an example in which, in a state where a three-dimensional shape includes a plurality of growth center points, the growth rule in FIG. 5 is applied to each growth center point. FIG. 12A illustrates a regular-icosahedron-shaped body in which each vertex is the growth center point. FIG. 12B illustrates an acoustic diffuser in which each vertex in FIG. 12A is the growth center point. As indicated in this example, a plurality of growth centers of each acoustic diffuser can be located at any positions.

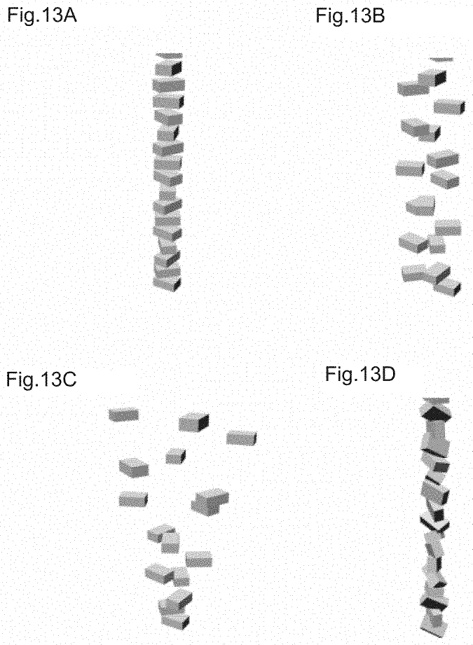

FIG. 13 is a plan view illustrating other examples of arrangement of units that form the acoustic diffuser. The axes are not indicated in FIG. 13. However, in these examples, rectangular-parallelepiped-shaped units are linearly displaced at a constant pitch in the not-illustrated Zw axis direction according to the above-described rule, and the scale is equal among the units. FIGS. 13A to 13C each illustrate a case where the units rotate around a rotation axis parallel to the Zw axis in increments of an angle α. FIG. 13A illustrates a case where the units do not revolve and the distance L from the Zw to the unit generation point G or the local coordinate originating point O1 of each unit is zero. FIG. 13B illustrates a case where the distance L from the Zw to the O1 or the like is constant, and the units revolve in increments of the angle α. FIG. 13C illustrates a case where the distance L from the Zw to the O1 or the like is increased in the structure in FIG. 13B. FIG. 13D illustrates a case where each unit is rotated about all the axes X1, Y1, Z1 in the local coordinates by the angle α in the structure in FIG. 13A.

FIGS. 14 and 15 illustrate the effect designed by the technique of the present invention. FIG. 14A illustrates a space formed by the first elemental surface SR and the second elemental surface SV designed according to the technique shown in FIGS. 1 and 2, and illustrates a wave front of a reflected wave in the case of a test sound wave being dissipated in all the directions from a point sound source at the center. It can be understood that the wave front of the reflected wave is dispersed in various directions, and the acoustic diffusion is appropriate, to prevent acoustic obstruction. Meanwhile, FIG. 14B illustrates a state where a similar test is performed in a room having a similar size and surfaces parallel to each other. The wave front of the reflected wave is continuous so as to be arc-shaped, and generation of acoustic obstruction may be anticipated.

FIG. 15A illustrates a state where the acoustic diffuser designed according to the techniques shown in FIGS. 4 to 13 is disposed in a closed space, and multiple small balls are caused to collide with the acoustic diffuser from the front face of the acoustic diffuser so as to be reflected. A state where the small balls are scattered and acoustic obstruction is prevented can be seen. Meanwhile, FIG. 15B illustrates a state where a similar test is performed by using an acoustic diffuser in which the unevenness is formed merely by parallel surfaces. The balls are reflected in a parallel manner and generation of acoustic obstruction may be anticipated.

Each of the elemental surfaces SR, SV, SH can be formed by a sound absorbing panel or the like as well as a general structural material. Furthermore, the acoustic diffusers O, OV, OH may be formed not only by using a mold, but may also be produced directly by a 3D printer, a 3D router, or the like. Examples of the material include ABS, ASA, nylon, acryl, polypropylene, polycarbonate, PLA (polylactic acid), each of these resins having carbon fiber or glass fiber mixed therein, gypsum, metal materials, and wood.

Each of the above-described units U may be formed by using a curved surface such as a Mobius strip as well as a polyhedral body, or may have a plate-like shape. An angle of the small face relative to a sound emitting direction is preferably changed by the revolution or rotation. However, acoustic radiation is generated at each vertex or corner. Therefore, relationship between the shape of each unit and the sound emitting direction may not necessarily matter.

The above-described embodiments may be combined to implement the present invention. The acoustic diffuser O designed according to the techniques shown in FIGS. 4 to 13 may be stored in a space surrounded by the elemental surface SR designed according to the technique in FIGS. 1, 2. Furthermore, nφ-times magnification or any magnification may be used instead of the φ-times magnification. By using the nφ or nα for either the dimensions or angle, acoustic obstruction is prevented.

### INDUSTRIAL APPLICABILITY

The present invention can be used as acoustic obstruction prevention equipment in, for example, concert halls, music schools, music studios, gymnasiums, and open-air concert facilities and a design method thereof.

### DESCRIPTION OF THE REFERENCE CHARACTERS

CS small face
Ce elemental face
F frame
P pillar
O acoustic diffuser
OV, Ov0, 1, 2 . . . vertical acoustic diffuser
OH, Oh0, 1, 2 . . . horizontal acoustic diffuser
SR, Sr0, 1, 2 . . . first elemental surface (elemental surfaces)
SV, Sv0, 1, 2 . . . second elemental surface (other elemental surfaces)
SH, Sh0, 1, 2 . . . third elemental surface (other elemental surfaces)
U, U0, 1, 2 . . . unit

1. An acoustic obstruction prevention equipment comprising
a plurality of elemental surfaces that form wall surfaces, a ceiling surface, or a floor surface which surround a space, wherein
an angle mutually formed by the elemental surfaces is nα (n is a natural number), and
acoustic obstruction is prevented by reflection between the elemental surfaces;
wherein:
$$φ = ( 1 + sqrt ( 5 ) ) / 2$$
$$α = 360 ° * 1 / ( 1 + φ ) .$$

2. An acoustic obstruction prevention equipment comprising:
a plurality of other elemental surfaces that form an acoustic diffuser disposed in a space, wherein
an angle mutually formed by the other elemental surfaces is nα (n is a natural number), and
acoustic obstruction is prevented by reflection between the other elemental surfaces or reflection between elemental surfaces surrounding the space and the other elemental surfaces;
wherein:
$$φ = ( 1 + sqrt ( 5 ) ) / 2 and$$
$$α = 360 ° * 1 / ( 1 + φ ) .$$

3. The acoustic obstruction prevention equipment according to claim 1, wherein
each of the elemental surfaces or each of the other elemental surfaces has a substantially rectangular shape, and
a length-width ratio of each of the elemental surfaces is 1:φ.

4. The acoustic obstruction prevention equipment according to claim 1, wherein
the wall surfaces, the ceiling surface, or the floor surface which surround the space form a substantially rectangular parallelepiped shape, and
a ratio of three sides of the rectangular parallelepiped is 1/φ:1:φ.

5. An acoustic obstruction prevention equipment comprising:
an acoustic diffuser disposed in a space, wherein
the acoustic diffuser includes a plurality of units,
the units have almost similar shapes or a same shape, and each unit has small faces on surfaces,
each unit is disposed such that an angle mutually formed by the units is nα (n is a natural number), and
acoustic obstruction is prevented by reflection between the small faces or reflection between elemental surfaces surrounding the space and the small faces,
wherein:
$$φ = ( 1 + sqrt ( 5 ) ) / 2 and$$
$$α = 360 ° * 1 / ( 1 + φ ) .$$

6. The acoustic obstruction prevention equipment according to claim 5, wherein mutual rotation, among the units, which defines angles mutually formed by the units includes revolution of each unit in a world coordinate system and/or rotation of each unit in a local coordinate system, the rotation of each unit defining an orientation of each unit.

7. The acoustic obstruction prevention equipment according to claim 5, wherein
the units in each acoustic diffuser are repeatedly formed so as to be displaced in the world coordinate system, and
a distance L between the units or a distance L between each unit and a reference axis in the world coordinate system or an originating point in the world coordinate system is defined by an equal magnification, any magnification, or an nφ times magnification (n is a natural number).

8. The acoustic obstruction prevention equipment according to claim 5, wherein each of the units in each acoustic diffuser is enlarged by an equal magnification, any magnification, or an nφ times magnification (n is a natural number).

9. The acoustic obstruction prevention equipment according to claim 5, wherein each of the units is a polyhedral body or a curved body.

10. The acoustic obstruction prevention equipment according to claim 1, further comprising
acoustic obstruction prevention equipment configured to include a plurality of other elemental surfaces that form an acoustic diffuser disposed in the space, and configured such that an angle mutually formed by the other elemental surfaces is nα (n is a natural number), and acoustic obstruction is prevented by reflection between the other elemental surfaces or reflection between elemental surfaces surrounding the space and the other elemental surfaces, wherein
the acoustic diffuser is disposed in the space surrounded by the plurality of elemental surfaces.

11. A design method of the acoustic obstruction prevention equipment according to claim 1, wherein
a plurality of elemental surfaces that form wall surfaces, a ceiling surface, or a floor surface which surround a space are provided,
an angle mutually formed by the elemental surfaces is nα (n is a natural number), and
the elemental surfaces are selected such that acoustic obstruction is prevented by reflection between the elemental surfaces;
wherein:
$$φ = ( 1 + sqrt ( 5 ) ) / 2 and$$
$$α = 360 ° * 1 / ( 1 + φ ) .$$

12. A design method of the acoustic obstruction prevention equipment according to claim 2, wherein
a plurality of other elemental surfaces that form an acoustic diffuser disposed in a space are provided,
an angle mutually formed by the other elemental surfaces is nα (n is a natural number), and
the elemental surfaces are selected such that acoustic obstruction is prevented by reflection between the other elemental surfaces or reflection between elemental surfaces surrounding the space and the other elemental surfaces;
wherein:
$$φ = ( 1 + sqrt ( 5 ) ) / 2 and$$
$$α = 360 ° * 1 / ( 1 + φ ) .$$

13. A design method of the acoustic obstruction prevention equipment according to claim 5, wherein
an acoustic diffuser is disposed in a space, and the acoustic diffuser includes a plurality of units,
the units have almost similar shapes or a same shape, and each unit has small faces on surfaces,
each unit is disposed such that an angle mutually formed by the units is nα (n is a natural number), and
the units are formed and disposed such that acoustic obstruction is prevented by reflection between the small faces or reflection between elemental surfaces surrounding the space and the small faces;
wherein:
$$φ = ( 1 + sqrt ( 5 ) ) / 2 and$$
$$α = 360 ° * 1 / ( 1 + φ ) .$$
